(19) United States
(12) Patent Application Publication
(10) Pub. No.: US 2026/0158523 A1
(43) Pub. Date: Jun. 11, 2026

(54) VACUUMING SYSTEM FOR SEPARATING UNDESIRABLE PARTICLES FROM LAND MATTER AND METHOD USING SAME

(71) Applicant: TECHNOLOGIE HOOLA ONE INC., Québec (CA)

(72) Inventors: Jean-David LANTAGNE, Québec (CA); Jean-Félix TREMBLAY, Rimouski (CA)

(21) Appl. No.: 18/869,016

(22) PCT Filed: May 29, 2023
(86) PCT No.: PCT/CA2023/050732

§ 371 Date: Nov. 25, 2024

Related U.S. Application Data
(60) Provisional application No. 63/346,950, filed on May 30, 2022.

(51) Int. Cl. B07B 7/06; B07B 7/01; E01H 1/08; E01H 12/00

(52) U.S. Cl. CPC B07B 7/06; B07B 7/01; E01H 1/0836; E01H 12/002

(57) ABSTRACT

There is described a vacuuming system for separating undesirable particles from land matter. The vacuuming system generally has a frame; a vacuum device mounted to the frame, the vacuum device having a vacuum generator and a vacuum conduit fluidly connected to the vacuum generator, the vacuum generator configured for creating a vacuum path along the vacuum conduit; and a separator assembly rotatably mounted to the frame, the separator assembly having an inner prismatic sieve having an inner cavity extending about a non-vertical rotation axis and receiving the vacuum path, and an outer prismatic sieve around the inner prismatic sieve, the inner prismatic sieve having inner pores sifting the undesirable particles through the inner prismatic sieve, and the outer prismatic sieve having outer pores smaller than the inner pores, the outer pores capturing the undesirable particles within the outer prismatic sieve.

### FIELD

The improvements generally relate to the field of vacuuming systems, and more specifically to vacuuming systems for removing particles from land matter.

### BACKGROUND

Natural landscapes have increasingly been the subject of undesirable landfill accumulation. This is particularly the case in lands having direct access to water such as beaches where waves, current and tides can bring in floating or otherwise stranded materials from the sea to the land or, on the contrary, can drag undesirable landfill to the sea.

The accumulation of plastic components is a particular hazard for marine life. Plastic components in the sea or on land are subject to a large combination of conditions such as rough weather, ultraviolet light irradiation or abrasion, for instance. This promotes a situation where large plastic components can break down into particles, making them more so difficult to identify and remove, while further becoming an increased risk for the marine life.

The removal of plastic particles from natural lands is challenging, especially when ecosystems and wet organic materials shifted simultaneously with the undesirable plastic particles need to remain undisturbed as much as possible in the process. Accordingly, there always remains room for improvement.

### SUMMARY

There are particular challenges in removing plastic particles from land matter. It is particularly the case in sandy lands which are often difficult to access, have varying granularity, and can be subject to varying degrees of humidity. Sandy lands can have complex ecosystems of small sand material combined with organic matter which can render removal of undesirable particles challenging, especially if the organic matter is to be left undisturbed.

The plastic particles are not only difficult to identify within the sandy land, such as by being partly covered by the sand, but are also difficult to separate from the sand once identified. The uneven land surface caused by the cyclical movement of the water, by animal movement on the surface, or even by the difference in the light incidence and reflection on the sand make it difficult for plastic particles to merely be removed by hand, for instance.

Further, sandy lands can be subject to different meteorological conditions which can vary mechanical properties of the land as a whole. For instance, wet or humid sand often form clumps which may require the matter to be manipulated in a different manner to achieve the same result. For instance, sifting sand through one's fingers may be a good manner of catching a piece of plastic for disposal in a bin, where the sand merely slides through one's fingers, leaving the object desired for manipulation in one's hand. However, this same technique may not be adequate in humid sand, where the sand can clump together. The material caught in this example may include the object, but it further includes sand which would be undesirably removed from the ecosystem.

The use of tools need to take into consideration these challenges while further considering the difficulty of access to these lands, which are sometimes only accessible by foot and bring about weight and size constraints, and the lack of resources available, such as lack of freely available electricity.

It was found that providing a vacuuming system comprising a vacuum device capable of vacuuming the land, capturing the surface land matter and directing the land matter towards a separator assembly having concentric rotatable prismatic sieves can alleviate at least some of the issues mentioned above. Such a standalone vacuuming system can be provided in the form of a mobile platform capable of separating plastic particles while returning fine materials, such as the sand, and coarse materials, such as organic matters, wood branches, algae, etc., back to the land, thus having a relatively low environmental impact.

In accordance with a first aspect of the present disclosure, there is provided a vacuuming system for separating undesirable particles from land matter, the vacuuming system comprising: a frame; a vacuum device mounted to the frame, the vacuum device having a vacuum generator and a vacuum conduit fluidly connected to the vacuum generator, the vacuum generator configured for creating a vacuum path along the vacuum conduit; and a separator assembly rotatably mounted to the frame, the separator assembly having an inner prismatic sieve having an inner cavity extending about a non-vertical rotation axis and receiving the vacuum path, and an outer prismatic sieve around the inner prismatic sieve, the inner prismatic sieve having inner pores sifting the undesirable particles through the inner prismatic sieve, and the outer prismatic sieve having outer pores smaller than the inner pores, the outer pores capturing the undesirable particles within the outer prismatic sieve.

Further in accordance with the first aspect of the present disclosure, the outer prismatic sieve can for example be longitudinally shorter than the inner prismatic sieve, thereby forming a longitudinal gap at the outer prismatic sieve.

Still further in accordance with the first aspect of the present disclosure, the vacuuming system can for example further comprise a receptacle at the longitudinal gap, the receptacle receiving the undesirable particles captured within the outer prismatic sieve.

Still further in accordance with the first aspect of the present disclosure, the vacuuming system can for example further comprise an auxiliary container assembly mounted to the frame and coupleable to the receptacle for receiving the undesirable particles therefrom when desired.

Still further in accordance with the first aspect of the present disclosure, the inner prismatic sieve can for example have a plurality of lifters protruding inwardly from an interior surface of the inner prismatic sieve.

Still further in accordance with the first aspect of the present disclosure, an interior surface of the outer prismatic sieve can for example be smooth around the outer pores.

Still further in accordance with the first aspect of the present disclosure, the inner prismatic sieve can for example have a partition mounted inside the inner prismatic sieve, the partition can for example be positioned across an axis parallel to the rotation axis and decelerating the undesirable particles moving along the inner prismatic sieve.

Still further in accordance with the first aspect of the present disclosure, the vacuuming system can for example further comprise a rotation mechanism engaged with the separator assembly and configured for rotating the inner and outer prismatic sieves about the rotation axis.

Still further in accordance with the first aspect of the present disclosure, the rotation mechanism can for example be engaged with at least one of the inner and outer prismatic sieves via a circumferential rib.

Still further in accordance with the first aspect of the present disclosure, the rotation mechanism can for example have an electric motor driving rotation of a wheel frictionally engaged with the circumferential rib.

Still further in accordance with the first aspect of the present disclosure, at least one of the inner and outer prismatic sieves can for example have a diameter ranging between 12 and 100 inches (in) and preferably between 20 and 35 in.

Still further in accordance with the first aspect of the present disclosure, a radial distance between the inner prismatic sieve and the outer prismatic sieve can for example range between 1 inch and 6 inches, and most preferably between 2 inches to 3 inches.

Still further in accordance with the first aspect of the present disclosure, the vacuum generator can for example be a rotary vane vacuum generator.

Still further in accordance with the first aspect of the present disclosure, the vacuum generator can for example have a nominal power ranging between 5 and 100 horsepower (HP) and preferably between 15 and 40 HP.

Still further in accordance with the first aspect of the present disclosure, the width can for example range between about 1 and 8 in and preferably between about 2 and 5 in.

Still further in accordance with the first aspect of the present disclosure, the vacuuming system can for example further comprise an integrator encompassing part of the vacuuming path, the integrator can for example direct the vacuuming path towards an auxiliary sieve member, the auxiliary sieve member can for example decelerate the land matter and leading the land matter towards the inner cavity of the inner prismatic sieve.

Still further in accordance with the first aspect of the present disclosure, the auxiliary sieve member can for example be an auxiliary prismatic sieve being rotatable about the rotation axis, the auxiliary prismatic sieve can for example be longitudinally abutted against the inner prismatic sieve.

Still further in accordance with the first aspect of the present disclosure, the integrator can for example have a scraper having a fixed edge abutted against an inner face of the prismatic strainer, the fixed edge can for example clear the inner face of the prismatic strainer and dislodging land matter thereon as the auxiliary prismatic sieve rotates.

Still further in accordance with the first aspect of the present disclosure, the integrator can for example have a casing covering at least partially the auxiliary sieve member, the casing can for example have at least an inner wall dividing the vacuuming path into a land matter path leading to the inner cavity of the inner prismatic sieve and an air path going across the auxiliary sieve member, the inner wall can for example decelerate air flowing along the air path.

Still further in accordance with the first aspect of the present disclosure, the integrator can for example have a rotative valve hermetically mounted at a bottom of the separation chamber, the rotative valve can for example carry the land matter from the separation chamber to the inner sieve while maintaining a vacuum.

In accordance with a second aspect of the present disclosure, there is provided a method of separating undesirable particles from land matter, the method comprising: accelerating the land matter along a vacuum path leading to a cavity of an inner prismatic sieve; rotating the inner prismatic sieve about a non-vertical rotational axis, said rotating including gravitationally sifting the undesirable particles from coarse land matter through the inner prismatic sieve and towards an outer prismatic sieve; and rotating the outer prismatic sieve about the non-vertical rotational axis, said rotating including gravitationally sifting fine land matter from the undesirable particles through the outer prismatic sieve and capturing the undesirable particles within the outer prismatic sieve.

Further in accordance with the second aspect of the present disclosure, the method can for example further comprise decelerating the land matter prior to arrival into the cavity of the inner prismatic sieve.

Still further in accordance with the second aspect of the present disclosure, the method can for example further comprise conveying the undesirable particles from the outer prismatic sieve to a receptacle area.

Still further in accordance with the second aspect of the present disclosure, the method can for example further comprise returning the coarse land matter and the fine land matter onto a land. In some embodiments, the coarse land matter and the fine land matter may not necessarily returned to the land. For instance, receptacle(s) can be used to collect the coarse land matter and fine land matter into a same receptacle or in two different, dedicated receptacles.

Still further in accordance with the second aspect of the present disclosure, the method can for example further comprise decelerating the undesirable particles within the inner prismatic sieve.

Still further in accordance with the second aspect of the present disclosure, at least one of the inner and outer prismatic sieves can for example have a rotation speed ranging between 10 5 and 50 revolutions per minute (RPM).

In accordance with a third aspect of the present disclosure, there is provided a vacuuming system for separating fine land matter from coarse land matter, the vacuuming system comprising: a frame; a vacuum device mounted to the frame, the vacuum device having a vacuum generator and a vacuum conduit fluidly connected to the vacuum generator, the vacuum generator configured for creating a vacuum path along the vacuum conduit; and a separator assembly rotatably mounted to the frame, the separator assembly having a prismatic sieve having an inner cavity extending about a non-vertical rotation axis and receiving the vacuum path, the prismatic sieve having inner pores sifting the fine land matter through the prismatic sieve and maintaining the coarse land matter therewithin.

Further in accordance with the third aspect of the present disclosure, the prismatic sieve maintaining undesired particles such as plastic pellets within the prismatic sieve together with the coarse land matter.

Still further in accordance with the third aspect of the present disclosure, the prismatic sieve is a first prismatic sieve, the vacuuming system can for example further comprise a second sieve being concentric to the first sieve. In some embodiments, the second sieve can have finer pores sifting through finer material, for instance. In some other embodiments, the second sieve is not concentric or around the first sieve, but longitudinally abutted thereto. In these latter embodiments, the first and second sieves can have similar diameters.

Still further in accordance with the third aspect of the present disclosure, the prismatic sieve can for example have a first series of first pores axially followed by a second series of second pores, the first pores can for example have a first dimension different from a second dimension of the second pores.

In accordance with a fourth aspect of the present disclosure, there is provided a separation system for separating undesirable particles from land matter, the system comprising: a frame; a separator assembly rotatably mounted to the frame, the separator assembly having an inner prismatic sieve having an inner cavity extending about a non-vertical rotation axis, and an outer prismatic sieve around the inner prismatic sieve, the inner prismatic sieve having inner pores sifting the undesirable particles through the inner prismatic sieve, and the outer prismatic sieve having outer pores smaller than the inner pores, the outer pores capturing the undesirable particles within the outer prismatic sieve.

Further in accordance with the fourth aspect of the present disclosure, the separation system can for example further include a conveyor system bringing the undesirable particles and the land matter within the inner prismatic sieve along a conveyor path.

Still further in accordance with the fourth aspect of the present disclosure, the conveyor system can include a brush or scraping member bringing the undesirable particles and the land matter from the ground and along the conveyor path.

Many further features and combinations thereof concerning the present improvements will appear to those skilled in the art following a reading of the instant disclosure.

### DESCRIPTION OF THE FIGURES

In the figures,

FIG. 1 is a schematic drawing of an example of a vacuuming system, shown with a vacuum generator and a separator assembly, in accordance with one or more embodiments;

FIG. 2A is an oblique view of an example of a separator assembly, shown with inner and outer prismatic sieves, in accordance with one or more embodiments;

FIG. 2B is a sectional view of the inner and outer prismatic sieves of FIG. 2A, taken along section 2B-2B of FIG. 2A, in accordance with one or more embodiments;

FIG. 3 is an oblique view an example of a vacuuming system incorporating the separator assembly of FIG. 2A, in accordance with one or more embodiments;

FIG. 4 is an exploded view of parts of the vacuuming system of FIG. 3, including a vacuuming device and a separator assembly fluidly connected to one another via an integrator, in accordance with one or more embodiments;

FIG. 5 is an oblique view of the integrator of FIG. 4, in accordance with one or more embodiments;

FIGS. 6A-6B are oblique views of the integrator of FIG. 4 while being engaged with the separator assembly of FIG. 4, showing respective partial and full casings, in accordance with one or more embodiments;

FIGS. 7A-7B are schematic views of alternate integrators having filter plates, in accordance with one or more embodiments;

FIG. 8 is a schematic view of an example of an integrator having a filter plate and a worm screw, in accordance with one or more embodiments;

FIG. 9 is a schematic view of an example of an integrator having an elbow directing land matter directly to sieves of a separator system, in accordance with one or more embodiments;

FIG. 10 is a schematic view of an example of an integrator having a solid plate, in accordance with one or more embodiments;

FIG. 11 is a schematic view of an example of an integrator having a cylindrical separator, in accordance with one or more embodiments;

FIG. 12 is a schematic view of an example of an integrator having a cyclone connected to a vacuum generator, where land matter is directed to a separator system via a valve, in accordance with one or more embodiments

FIGS. 13A and 13B show oblique views of another example of a wheeled vacuuming system, in accordance with one or more embodiments;

FIG. 14A is an oblique view of an example of a plastic pellet receptacle coupled to a gap of the separator assembly of the wheeled vacuuming system of FIG. 13A; and

FIG. 14B includes oblique views of different modes of operation of an auxiliary container assembly coupleable to the plastic pellet receptacle of FIG. 14A.

### DETAILED DESCRIPTION

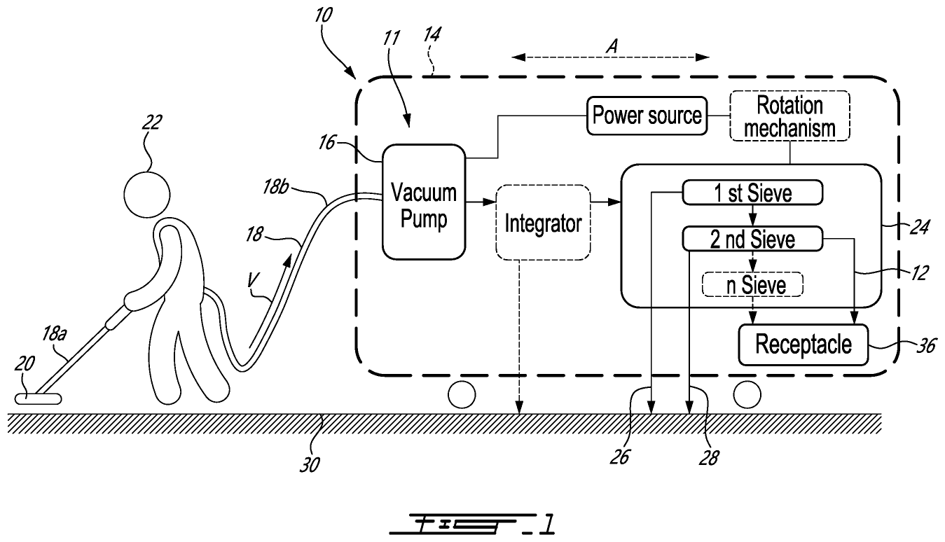

FIG. 1 shows a schematic drawing of a vacuuming system 10 for separating undesirable particles 12 from land matter, in accordance with an embodiment. The vacuum system 10 has a frame 14 and a vacuum device 11 which is mounted to the frame 14. The frame 14 can be mobile in some embodiments and fixed in some other embodiments. As depicted, the vacuum device 11 has a vacuum generator 16 and a vacuum conduit 18 which is fluidly connected to the vacuum generator 16. The vacuum generator 16 can be fluidly connected to the vacuum conduit 18 at an upstream or downstream location. During use, the vacuum generator 16 draws land matter from a distal end 18a to a proximal end 18b of the vacuum conduit 18. In this specific example, the vacuum conduit 18 is provided in the form of a flexible hose having a nozzle 20 at the distal end 18a. The flexible hose can be manipulated by a user 22 as needed for the vacuuming operation to take place. In some other embodiments, the vacuum conduit 18 can be rigid or articulated. In some embodiments, one or more handles are provided to the vacuum conduit 18 to ease manipulation. As depicted, the vacuum generator 16 is connected to a separator assembly 24 receiving the land matter vacuumed from a land 30. The vacuum generator 16 and the vacuum conduit 18 collectively form a vacuum path V beginning at the nozzle 20 and ending within an inner cavity of the separator assembly 24.

In this embodiment, the separator assembly 24 has first and second sieves. More specifically, the first and second sieves are prismatic in shape and are rotatable about a non-vertical rotational axis. The prismatic shape of the first and second sieves can be cylindrical in some embodiments. In some embodiments, the first and second sieves are concentric in a way that rotation occurs about a common non-vertical rotational axis. Preferably, the non-vertical rotational axis is slightly inclined with respect to the horizon. As such, in an embodiment where only two prismatic sieves are provided in the separator assembly 24, the first prismatic sieve may be referred to as an inner sieve while the second prismatic sieve may be referred to as an outer sieve extending around the inner sieve. The inner prismatic sieve has inner pores sifting the undesirable particles through the inner sieve while the outer sieve has outer pores smaller than the inner pores so as to capture the undesirable particles therein. It is noted that as the inner and outer sieves rotate, the land matter shifts therein. The land matter is first being shifted in the inner sieve. As such, the undesirable particles 12 gravitationally sift through the inner pores of the inner sieve, thereby dissociating from coarse land matter 26. The sifted matter being led to the outer sieve is further shifted within the outer sieve as it rotates, permitting the sifting of fine land matter 28 from the undesirable particles 12, resulting in the capture of the undesirable particles 12 within the outer sieve. Examples of coarse land matter can include, but are not limited to, pebbles, branches, algae, and the like. Examples of fine land matter can include, but are not limited to, sand, powders and the like. It is understood that more than two sieves can be provided in alternate embodiments, and that any number of sieves can be used with varying pore dimensions for the purposes of the vacuuming system without departing from the present disclosure. In some embodiments, only one prismatic sieve can be used. For instance, in these embodiments, the vacuuming system can be used for separating fine land matter from coarse land matter. More specifically, the vacuuming system has a frame, a vacuum device mounted to the frame and a separator assembly rotatably mounted to the frame. It is intended that the separator assembly can have a single prismatic sieve having an inner cavity which extends about a non-vertical rotation axis and which receives the vacuum path. In these embodiments, the prismatic sieve has inner pores which sift the fine land matter through the prismatic sieve and maintain the coarse land matter therewithin. As such, undesirable particles such as plastic pellets can be maintained within the single prismatic sieve together with the coarse land matter. In these situations, the second sieve, or outer sieve, can be omitted. In some embodiments, the single prismatic sieve can have two series of differently sized and shaped pores along its length. For instance, the single prismatic sieve can have a first series of inner pores sifting the fine land matter, a second series of outer pores sifting the undesirable particles such as plastic pellets, and then an optional third series of even bigger pores sifting the coarse land matter therethrough. In such an example, the second series of pores follows the first series of pores, and the third series of pores follows the second series of pores, along the length of the prismatic sieve. Accordingly, the two functions of filtering both the fine land matter and the undesirable particles can be achieved using a single sieve which would have differently sized and shaped pores along its length.

In the illustrated embodiment, the coarse land matter 26 captured in the inner sieve and the fine land matter sifted through the outer sieve are ultimately conveyed back to the land 30, whereas the undesirable particles 12 are conveyed to a receptacle 36 for storage and disposal.

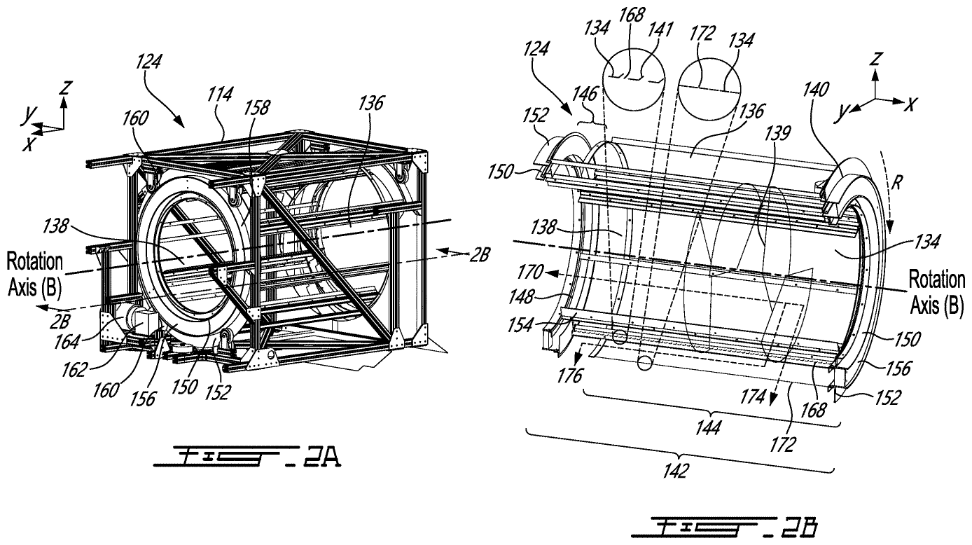

Attention is now brought to FIGS. 2A and 2B which show a specific example of a separator assembly 124. As shown, the separator assembly 124 has inner and outer sieves 134 and 136. In this example, the inner and outer sieves 134 and 136 are cylindrical in shape. As depicted, the inner and outer sieves 134 and 136 extend along a longitudinal orientation, and are concentric to one another about a common non-vertical rotation axis B. As is perhaps best seen in FIG. 2B, the inner sieve 134 forms an inner cavity 138 therein which is open at both longitudinal ends of the inner sieve 134. The vacuum path created by a vacuum generator and a vacuum conduit generally leads to the inner cavity 138 of the inner sieve 134. As such, the vacuum path can enter the inner cavity 138 via one of its longitudinal ends.

The inner and outer sieves 134 and 136 have a common longitudinal end 140. In this example, the outer sieve 136 is shorter than the inner sieve 138. More specifically, the inner sieve 134 has a first length 142 while the outer sieve 136 has a second length 144 which is smaller than the first length 142. The difference in length between the inner and outer sieves 134 and 136 form a longitudinal discontinuity spanning an outer sieve perimeter such as to form a longitudinal gap 146. As seen in FIG. 2B, in this embodiment, the gap 146 is formed at the opposite longitudinal end 148 from the common longitudinal end 140. In this case, the outer sieve 136 can be said to be shorter than the inner sieve 134 as it is cut short forming the gap 146 at the opposite longitudinal end 148. However, it is understood that in alternate embodiments, the longitudinal discontinuity of the outer sieve 136 can be formed in any longitudinal location along the first length 142, such as in the middle or proximal to the common longitudinal end 140, for instance, without departing from the present disclosure.

Still referring to FIGS. 2A and 2B, the inner and outer sieves 134 and 136 have inner and outer circumferential ribs 150 and 152 at each longitudinal end. The inner sieve 134 is provided between the two inner circumferential ribs 150 found at the opposite longitudinal ends 140 and 148 of the inner sieve 134. Similarly, the outer sieve 136 is provided between the two outer circumferential ribs 152 found at the opposite longitudinal ends 140 and 148 of the separator assembly 124, adjacent to and concentric with the respective inner circumferential ribs 150.

It is noted that, in the present embodiment, the outer circumferential ribs 152 are connected to one another via one or more slats 154 which bridge the outer sieve 136 with the outer circumferential ribs 152 across the gap 146 formed by the discontinuity of the outer sieve 136. It is understood that in other embodiments, the slats may be replaced by another body having a different structure or omitted altogether without departing from the present disclosure. Each slat generally has a length extending longitudinally within the inner sieve and a width extending radially inwardly towards a center of the inner sieve 134. In some embodiments, the width of the slat ranges between about 1 and 8 in and preferably between about 2 and 5 in. It is noted that the slats can help bring land matter up in the inner sieve 134 as it rotates. At some point, the land matter falls back at a bottom of the inner sieve 134 thereby forcing land matter to dissociate from the undesirable particles that are expected to sift through the inner sieve 134. The width of the slats can define how much land matter is moved upwards as the inner sieve 134 rotates. Although the slats are formed from a flat body in this example, slats can be provided with curved shape in some other embodiments. In some embodiments, the slats can be omitted. For instance, an endless screw (or other mechanism) concentrically disposed within the inner sieve 134, and rotating therewith, can be used to force the matter into and along the inner sieve 134 during use of the vacuuming system.

As shown in FIG. 2A, the inner and outer circumferential ribs 150 and 152 are connected to one another at both ends via a link member 156. As shown, the link member 156 forms an annular structure which bridges the radial space between the inner and outer circumferential ribs 150 and 152 and mechanically links the inner and outer sieves 134 and 136 to one another. In this manner, when the inner sieve 134 performs a rotation R about the rotational axis B, the outer sieve 136 follows suit, or vice versa. It is understood that in alternate embodiments, however, it may be desirable to dissociate the inner and outer sieves such that they may rotate at different speeds or even rotate in opposite directions, without departing from the present disclosure.

The inner and outer circumferential ribs 150 and 152 are generally annular and have a generally L-shaped or flanged cross-section, forming circumferential flat surfaces 158. As depicted, wheels 160 permit the engagement of the inner and outer sieves 134 and 136 with a portion of the frame 114, while maintaining the rotation capacity of the inner and outer sieves 134 and 136 about the rotational axis B. It is understood, however, that other rib cross-sections are possible without departing from the present disclosure. For instance, in another embodiment, the outer rib may remain identical as the one shown in FIGS. 2A and 2B, forming a flat surface for engagement with the wheels of the separator assembly, but the inner circumferential rib may have a different cross-sectional structure, such as an I-beam like cross section or the like.

As depicted, a rotation mechanism 162 is also provided with an electrical motor 164. The rotation mechanism 162 can drive the wheel 160 which is drivingly abutted against the flat surface 158 formed by the outer rib 152. The electric motor 164 drives the wheel 160 interfacing with the rib 152 when actuated, providing the rotation R to the inner and outer sieves 134 and 136 around the rotation axis B. In some embodiments, the motor needs not to be electric. In fact, the motor can be electric, hydraulic or combustion-based, depending on the embodiment. The rotation mechanism 162 in this embodiment can be powered by the same power source 166 as a vacuum generator, but it is understood that an alternate power source, such as electricity generated through a solar panel or through simply an independent power source from that of the vacuum generator for instance, may be used without departing from the present disclosure. It is also understood that the rotation mechanism can be any mechanism to this effect without departing from the present disclosure. For instance, in another embodiment, the electrical motor may turn a gear which interfaces with the one of the inner and outer sieves. In yet another embodiment, the vacuuming system may be provided with a hand crank which when manually actuated rotates the wheel interfacing with the outer circumferential rib or a mechanical system which harvests mechanical power from the displacement of the vacuuming system through the frame's tires. The circumferential ribs can be omitted in some embodiments, as wheels can be interfaced directly on either one of the inner and outer sieves 134 and 136 in some other embodiments.

For the purpose of providing an example as to the operation of the separator assembly 124, an example of land matter being provided from a beach will be discussed. In this example, the land matter is a mix of sand, whether it be dry or humid, organic matters such as branches, algae, etc. and plastic pellets which are the undesired particles in this particular example. The mixture of land matter is drawn by a vacuum system and provided in the inner cavity 138 of the inner sieve 134.

The inner and outer sieves 134 and 136 both rotate about the rotation axis B, such that the mixture of sand, organic matter and plastic pellets are shifted, by gravitational forces, an endless screw, or both, as the sieves 134 and 136 are rotated. As previously discussed, the inner sieve 134 has inner pores 168, which are sized to permit the sifting of the undesirable particles which in this case are the plastic pellets. However, as sand has a size smaller than that of the inner pores 168, both the sand and the plastic pellets are sifted through the inner pores of the inner sieve 134 towards the outer sieve 136. The organic matter, being larger than the inner pores 168 of the inner sieve 134, are captured by the inner sieve 134 and remain in the inner cavity 138 until they are ultimately returned to the land at the end 148 of the inner sieve 134, acting as an organic matter output 170.

The sand and plastic pellets having sifted through the inner sieve 134 are received within an annular volume extending between the inner sieve 134 and the outer sieve 136. The sand and plastic pellets are gravitationally shifted against the outer sieve 136 as it is rotated. As discussed above, the outer sieve 136 has outer pores 172 sized to capture the undesirable particles, which are the plastic pellets in this case. To this effect, the size of the outer pores 172 permits the sifting of the sand through the outer sieve 136, such as to return the sand to the land via sand output 174. All the while, the plastic pellets are captured in the outer sieve 136 and are ultimately conveyed towards the gap 146 forming the plastic pellet output 176.

In the example above, the inner pores 168 have a size of ¼ inch, such as to permit land matter having a size equal or less to ¼ inch to sift through the inner sieve 134, while the outer pores 172 have a size of ⅛ inch, such as to permit the land matter having gone through the inner sieve 134 and with a size equal or less to ⅛ inch to sift through the outer sieve 136. The undesirable particles captured in this case having a size between ⅛ and ¼ inch.

Referring now specifically to FIG. 2B, the separator assembly 124 is inclined so plastic pellets incoming from the integrator with too much kinetic energy may bounce off the inner sieve 134 and amass at the distal end of the inner sieve 134, thereby preventing their filtering. In those embodiments, partitions 139 are disposed within the inner sieve 134 to prevent the bouncing of the plastic pellets in a way which reduces their kinetic energy and force them to rest onto the inner sieve 134 where they can fall through the inner pores 168 of the inner sieve 134 prior to reaching the distal end of the inner sieve 134. In this example, the partitions 139 are axially spaced apart from one another. The partitions 139 can be oriented laterally across the rotation axis B of the inner sieve 134. In some embodiments, each partition 139 covers a respective circumferential arc of the inner sieve 134.

As shown in the left-hand side inset of FIG. 2B, the inner pores 168 of the inner sieve 134 can be provided with lifters 141 which are sized and shaped to turbulently lift the land matter thereby forcing or otherwise enhancing the separation of the plastic pellets from the land matter within the inner sieve 134. In some cases, the lifters 141 are not necessarily provided by a shape or surrounding of the inner pores 168. Rather, the lifters 141 can originate from the construction of the inner sieve 134, which may not be smooth and continuous. For instance, the inner sieve 134 can be constructed on the basis of two or more axial or circumferential sections which are mounted to one another. As discussed, the lifters 141 can stem from a rough connection between these sections. In contrast, and now referring to the right-hand side inset of FIG. 2B, the outer pores 172 of the outer sieve 134 do not have such lifters. Indeed, the outer pores 172 are sized and shaped to be as smooth as possible, thereby preventing the plastic pellets from bouncing back into the inner sieve 134 via the inner pores 168.

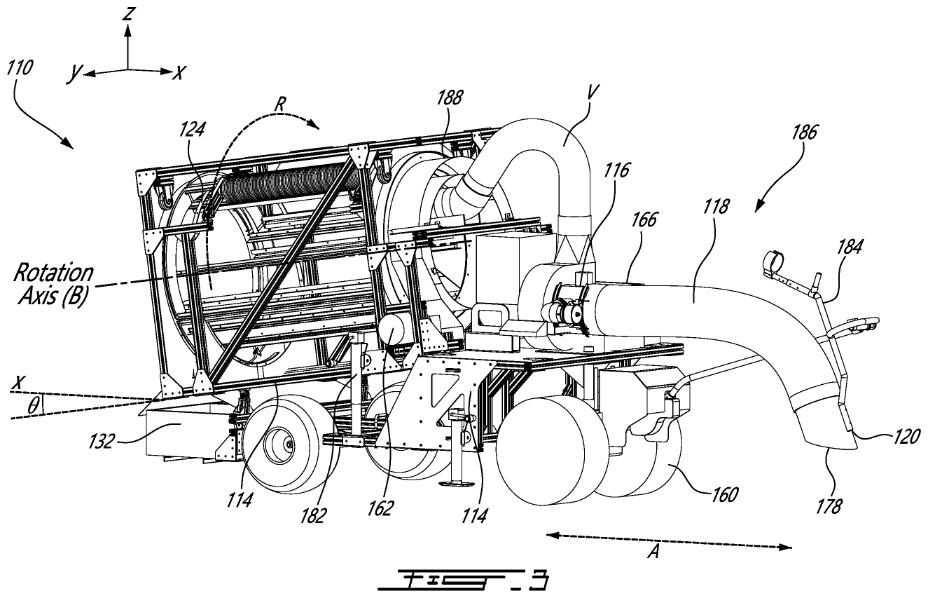

Attention is now brought to FIG. 3 showing the separator assembly 124 as part of a wheeled vacuuming system 110. In the present example, the vacuuming system 110 is a standalone apparatus having tires 160 in order to permits its displacement A. The frame 114 extends such as to hold the vacuum generator 116 and a power source 166 in front of the separator assembly 124. As shown, the vacuum generator 116 has a vacuum conduit 118 having a first portion extending forwardly towards a nozzle 120 and forming a vacuum inlet 178, and a second portion extending backwardly towards the separator assembly 124. The vacuum system 110 has a vacuum path V along the vacuum conduit 118. The vacuum path V extends from the nozzle 120 to the inner cavity 138 of the inner sieve 134. Accordingly, land matter is drawn from the land up along the vacuum path V until the land matter reaches the inner cavity 138 of the inner sieve 134.

In this embodiment, the frame 114 has a jack 182 which permits vertical pivotal of the separator assembly 124 from the rest of the vacuuming system 110. In this manner, the separator assembly 124 can be pivoted to any desired angle e from the horizontal x. The pivot of the separator assembly 124 brings about the corresponding pivot of the rotation axis B. The angle O permits for gravitational progression of the land matter received for separation longitudinally as the matter is shifted during the rotation of the inner and outer sieves 134 and 136. It is understood that the angle O of use will depend on a variety of factors, such as the speed of rotation of the sieves, the land matter being separated and/or the inclination of the land on which the vacuum system 110 lies with respect to the horizontal x (or the gravitational forces). It is also understood that the angle O need not be constant during operation and can be adjusted as necessary based on the particular circumstances the vacuuming system 110 is used in.

The angle ⊖ permits the capture of the undesirable particles in the outer sieve 136 to be gradually conveyed to the gap 146, provided at the lowest point of the pivoted separator assembly 124 in this embodiment. A receptacle 132 is provided at the gap 146 and more specifically under the gap 146, such that the undesirable particles gravitationally fall out of the outer sieve 136 through the gap 146 and into the receptacle 132 for collection. In this manner, the inner and outer sieves 134 and 136 are self-emptying, such that the vacuuming system 110 may be operated continuously without the need to manually empty the inner and outer sieves 134 and 136 and unnecessarily subjecting the rotation mechanism 162 to the task of rotating a large quantity of undesirable particles accumulated therein.

Still referring to FIG. 3, the vacuum conduit 118 extends forwardly in front of the wheeled frame 114. The vacuum conduit 118 is made of a resilient and flexible material, permitting it to be bend with ease when manipulated by a user. To this end, a handle 184 is attached to the nozzle 120 such as to permit a user to move the vacuum conduit 118 as desired, or more specifically the nozzle 120 thereof, towards the land matter which needs to be cleaned. In this particular embodiment, the handle 184 further has a member extending towards the frame 114 of the vacuuming system 110, which permits directing and displacing the system 110 in accordance with the direction desired by the user manipulating the vacuum conduit nozzle 120. It is understood that the vacuum conduit 118 may be provided with articulated features to provide a larger bending range without departing from the present application.

In this particular embodiment, the vacuum generator 116 is a rotary vane vacuum generator. However, it is understood that any other suitable pump may be used without departing from the present disclosure. It is understood that the exact operating parameters of the vacuuming system 110 can vary based on the land matter to be separated. However, it was determined that having a vacuum generator 116 with a nominal power output ranging between 5 and 100 horse power (HP), and more preferably between 15 and 40 HP, was sufficient for the purposes of drawing land matter. The diameter of the vacuum conduit 118 can range between 2 and 20 inches, and preferably between 3 and 15 inches. In some embodiments, the vacuum device is configured to draw a flow rate ranging between 100 and 10000 cubic feet per minute (CFM), and preferably between 2000 and 5000 CFM.

It was further determined that having inner and outer sieves 134 and 136 with diameters between 12 and 100 inches, and preferably between 20 and 50 inches. The inner and outer sieves 134 and 136 can have first and second lengths 142 and 144 ranging between 15 and 100 inches, and preferably between 25 and 50 inches. In some embodiments, a radial distance separating the inner prismatic sieve 134 from the outer prismatic sieve 136 ranges between 1 inch and 6 inches, and most preferably between 2 inches to 3 inches. The rotation speed can vary depending on the embodiment. However, rotations speeds ranging between 5 and 50 revolutions per minute (RPM), and preferably between 20 and 35 RPM, were found to be sufficient for separating undesirable particles from most land matters.

It was further determined that pivoting the separator assembly 124 from the horizontal (x) by between 1 and 20 degrees, and preferably between 3 and 10 degrees, can be sufficient conveyance for the land matter to be conveyed along the inner and outer sieves 134 and 136 for the purposes of separation as described above.

The above parameters have been determined to be most preferable in the separation of undesirable particles from sandy land matter. However, it is understood that the operating parameters identified above are non-limitative and provide only examples for adequate performance of the vacuuming system. Other parameter combinations are possible without departing from the present disclosure. For instance, in an alternate embodiment, the slat(s) of the of the inner and outer sieves can be provided in the form of spiralling blades such as to progressively push the land matter along the length of the inner and outer sieves. In such embodiments, the vacuuming system may have a null pivot angle ⊖ (i.e., a pivot angle ⊖ of 0), and the rotational speed of the sieves may be reduced to ensure that the land matter separation occurs as desired, for instance. In yet another embodiment with spiralling blades, the pivot angle ⊖ may be maintained. In this example, the spiralling blades may slow the longitudinal progression of the land matter being shifted through the rotation of the inner and outer sieves, ensuring that the land matter is shifted for a desired amount of time (or turns, which in this case would be directly related to the rotational velocity of the sieves).

Still referring to FIG. 3, in this embodiment, the vacuum device 186 has an integrator 188 encompassing part of the vacuum path V. The integrator 188 is configured for directing the vacuum path towards an auxiliary sieve member which can decelerate the land matter moved along the vacuum path V and lead the decelerated land matter towards the inner cavity 138 of the separator assembly 124.

The flow rate provided by the vacuum generator 116 permits the drawing of the land matter towards the vacuuming system 110 via the nozzle 120 of the vacuuming conduit 118 without the need for an additional scraper, shovel contraption or manual intervention. The flow rate of the vacuum generator 116 also brings about the challenge of receiving the land matter in the inner sieve 134 without the land matter being propelled across the cavity 138 in an uncontrolled manner. This is particularly the case where a large flow rate is desired such as to draw the land matter with ease through the nozzle 120, but the same flow rate may further undesirably push the receive land matter far out along the separator assembly 124. The integrator 188 thus permits decelerating the land matter and dissociating the land matter from the remaining fluid, in this case air, being propelled by the vacuum generator 116 while maintaining a satisfactory continuity in the delivery of the drawn land matter to the inner cavity 138.

Reference is now made to FIG. 4 showing an exploded view of the vacuuming system 110. As depicted, the integrator 188 lies between the vacuum device 186 and the separator assembly 124. The integrator 188 receives the output of the vacuum generator 116 in this embodiment, which directs the drawn land matter through an elbow 190 generally radially against an auxiliary sieve member 191. As shown, the auxiliary sieve member 191 is an auxiliary prismatic sieve 192 which is rotatable about the rotation axis. In this embodiment, the auxiliary prismatic sieve 192 is longitudinally abutted against the inner prismatic sieve 134. In this particular embodiment, the auxiliary prismatic sieve 192 is cylindrical such as to match the inner cylindrical sieve 134 of the separator assembly 124. As illustrated, the auxiliary prismatic sieve 192 is abutted against the separator assembly 124, and more specifically engaged with the inner rib 150 at the common longitudinal end 140. In this configuration, the auxiliary prismatic sieve 192 can be said to extend longitudinally from the common longitudinal end 140, but contrary to the inner cylindrical sieve 134, the auxiliary prismatic sieve 192 extends in the longitudinal direction opposite that of the inner sieve 134, forming an extension thereof.

While the integrator 188 in this embodiment has cylindrical sieve and conduit, it is understood that other prismatic shapes may be used without departing from the present application. For instance, should the inner and outer prismatic sieves have a square cross-section, the auxiliary prismatic sieve may also be configured to have a corresponding square perimeter. It is further understood that the inner and outer prismatic sieves and the auxiliary prismatic sieve need not have identical perimeters, both in terms of shape and dimensions.

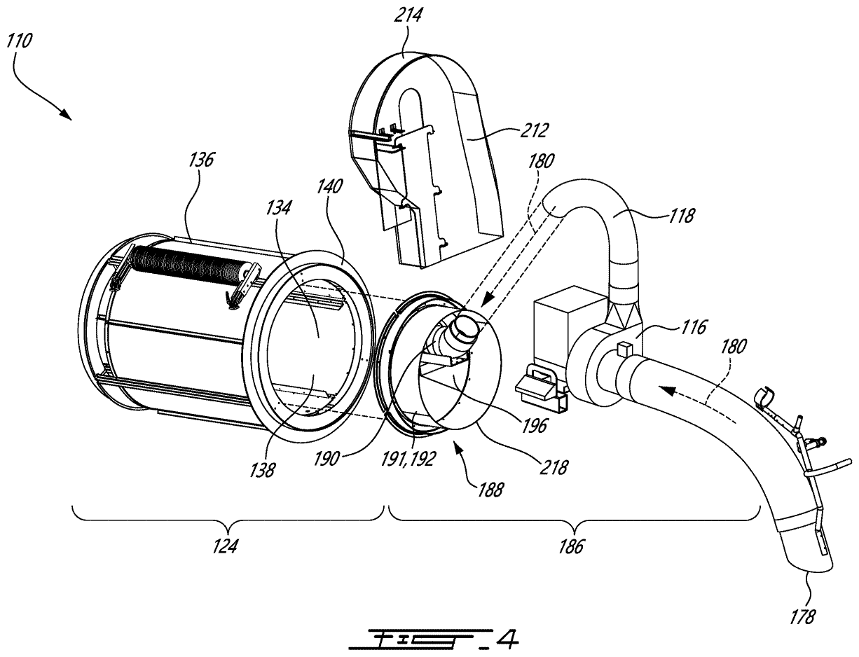

As shown in FIG. 5, showing an oblique view of the integrator of FIG. 4, the auxiliary prismatic sieve 192 has a circumferential rim 194 which engages with the inner circumferential rib 150 of the separator assembly 124 at the common longitudinal end 140. In this manner, the auxiliary prismatic sieve 192 is concentric with the inner and outer sieves 134 and 136. As such, the inner and outer sieves 134 and 136 and the auxiliary prismatic sieve 192 can be rotated simultaneously via the actuation of the same rotation mechanism 162.

In contrast to the auxiliary prismatic sieve 192, the elbow 190, the stopper plate 196 and a scraping blade 198 are held static via a cross bar 200, which is further engaged to the frame 114. As is shown in dashed lines, the land matter drawn from the vacuum generator 116 is propelled through the elbow 190 and out through the integrator input 202 in a general radial direction, and against the auxiliary prismatic sieve 192. The auxiliary prismatic sieve 192 has auxiliary pores 204 sized to at least permit the transmission of air 206 there through. However, it is understood that the auxiliary pores 204 may be chosen to be of any size below that of the undesirable particles without departing from the present application. For instance, with reference to the organic matter, sand and plastic pellets land matter in the previous example, the auxiliary pores can have a size corresponding to the outer pores of the outer sieve, such as to permit both the air and the sand to be transmitted through the auxiliary prismatic sieve. It is important to note that, even if the auxiliary pores are sized such as to theoretically permit the transmission of sand there through, only a portion of the sand may pass through the auxiliary sieve member, as the volume of land matter being propelled renders the transmission of the sand difficult or inefficient in at least some instances. As such, a portion of the land matter having a size smaller than that of the auxiliary pores can nevertheless remain and be directed towards the inner cavity of the inner sieve for separation.

Still referring to FIG. 5, the land matter propelled from the elbow 190 is directed along the perimeter of the auxiliary prismatic sieve 192 gravitationally downwards under the stopper plate 196, where it is free to convey to the inner cavity 138 of the inner sieve. The stopper plate 196 extends over a top portion of the cross section along a second end 208 of the integrator 188, proximal to the separator assembly 124, such as to avoid the dispersion of the high velocity land matter within the separator assembly 124. In this particular embodiment, the stopper plate 196 extends over at least half of the cross section, primarily in the upper half of the integrator 188.

In this embodiment, the auxiliary prismatic sieve 192 and inner and outer sieves 134 and 136 rotate about the rotation axis B. The elbow 190 of the integrator 188 is configured to direct the drawn land matter 210 towards the auxiliary prismatic sieve 192 radially and along the direction of rotation R, ultimately bringing the received land matter 210 under the stopper plate 196, and permitting the land matter 210 to gravitationally shift downwards and towards the inner cavity 138 of the separation assembly 124.

The scraping blade 198 is provided proximal to the elbow 190 in the upper half of the integrator 188. The scraping blade 198 has a fixed edge abutting against the inner face of the auxiliary prismatic sieve 192 such as to clear the inner face of the auxiliary prismatic sieve 192 and dislodge any land matter 210 which may have become stuck thereon, directing the matter 210 back downwards towards the inner cavity 138, as the auxiliary prismatic sieve rotates. In this particular embodiment, the scraping blade 198 is a plate, but it is understood that in alternate embodiments, the scraping blade can be any suitable body which can dislodge stuck land matter 210 from the auxiliary prismatic sieve 192 as the auxiliary prismatic sieve rotates. For instance, in an alternate embodiment, the scraping blade 198 may be any type of scraper or brush with resilient bristles brushing the inner face of the strainer as it rotates.

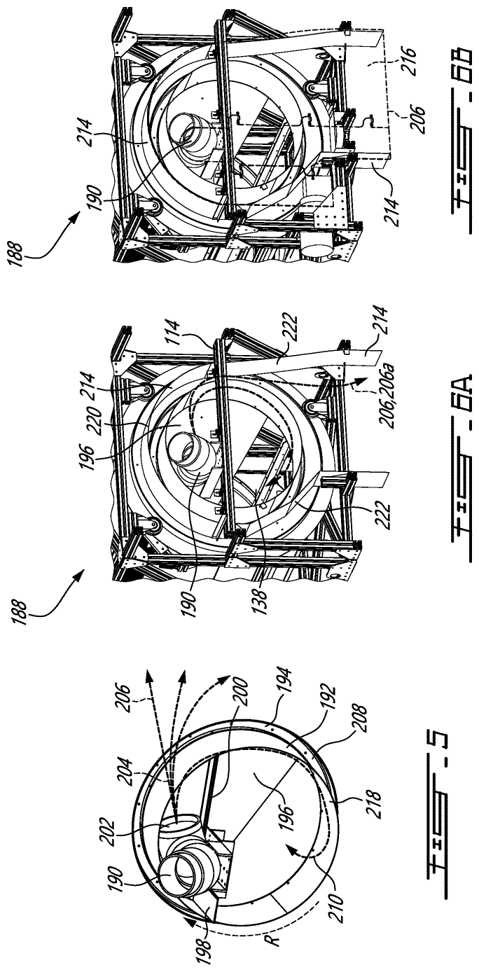

As shown in FIGS. 6A and 6B, the integrator 188 can be engaged with the separator assembly 124 with a partial casing and a full casing, respectively. A casing 212 is used to avoid the dispersion of the propelled land matter away from the inner cavity 138 of the inner sieve 134, while further directing the air 206 passing through the auxiliary prismatic sieve downwards. As shown, the casing 212 covers at least partially the auxiliary prismatic sieve 192. The casing 212 has at least an inner wall dividing the vacuum path into a land matter path leading to the inner cavity 138 of the inner sieve 134 and an air path 206a going across the auxiliary prismatic sieve 192 and then leading downwards. In some other embodiments, the air path 206a can lead upwards and/or along a lateral orientation. In these embodiments, the air path 206a can lead within dust bag(s) capturing dust and letting air sift through the dust bag(s). As such, the inner wall of the casing 212 can decelerate air flowed along the air path 206a.

The casing 212 can include a sleeve 214 and a cover plate 216. As depicted, the cover plate 216 covers the cross section of the auxiliary prismatic sieve 192 at the first end 218 thereof, opposite the second end 208 of the auxiliary prismatic sieve 192 where the stopper plate 196 is provided. The cover plate 216 has an opening to permit the snug introduction of the elbow 190 within the prismatic auxiliary prismatic sieve 192 of the integrator 188. In this embodiment, the cover plate 216 blocks the propelled land matter from dispersing away from the inner cavity 138 of the inner sieve 134. As such, the land matter 210 being propelled from the elbow 190 is directed towards the auxiliary prismatic sieve 192 and initially confined between the stopper plate 196 and the cover plate 216. The land matter 210 gravitationally shifting downwards, simultaneously with the rotation of the auxiliary prismatic sieve 192, and towards the inner cavity 138.

As depicted, the sleeve 214 can be circumferentially surrounding a portion of the perimeter of the auxiliary prismatic sieve 192. The sleeve 214 has a width corresponding to the longitudinal dimension of the auxiliary prismatic sieve 192 extending along the rotation axis B, and can be said to extend between planes formed by the first and second ends 218 and 208 of the auxiliary prismatic sieve 192.

In this particular embodiment, the sleeve 214 forms an hemispherical arc 220 along the upper half of the auxiliary prismatic sieve 192, and offset radially from the center of the auxiliary prismatic sieve 192 itself. The arc 220 interfaces with arms 222 which extend from the opposite sides of the arc 220 generally downwards. As is seen in FIG. 6B, the cover plate 216 extends past the cross section of the auxiliary prismatic sieve and extends towards the sleeve 214 formed by the arc 220 and the arms 222. The resulting casing directs the high-speed air and the limited matter that may also pass through the auxiliary prismatic sieve 192 downwards towards the land. This limits propelling sand, for instance, away from the vacuum system 110 or towards other components of the vacuum system 110 in which it is undesirable for land matter to accumulate, such as the power source for instance.

It is understood that the integrator 188, and the respective casing 212 thereof, shown in FIGS. 4-6B are examples only and are not to be construed as limitative in any way. For instance, in an alternate embodiment, the sleeve of the casing may not have the arms and may only be provided with the half-circle arc covering the upper half of the auxiliary prismatic sieve. In yet another embodiment, the integrator may have no casing at all and simply a cover plate extending over the cross section of the auxiliary prismatic sieve at the first end to avoid the dispersion of the propelled land matter. The integrator is only optional as it can be omitted in some other embodiments. The integrator can also be used alone as a standalone device in some other embodiments. In these latter embodiments, the integrator may not be incorporated into the system described therein or used in conjunction with a vacuum device and/or a separator assembly.

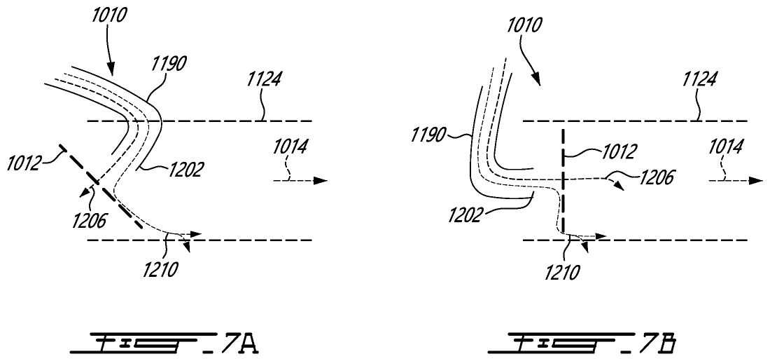

Attention is now brought to FIGS. 7A to 12 showing alternate integrators in accordance with other embodiments. For the sake of conciseness, only the differences between these embodiments are described. While these figures only use a pair of dashed horizontal lines to show the separator assembly 1124, it is understood that the separator assembly in these embodiments correspond to any one of the embodiments and alternatives discussed above. More so, while the schematic separator assembly in these figures are shown as being generally horizontally oriented, it is understood that the assembly 1124, as well as the integrators discussed, may be pivoted as previously discussed. It is further understood that, while the following examples discuss filters having pores such as to permit the air to pass through, the pores may be any suitable size which captures the undesirable particles while fluidly uncoupling the air from the material. In this matter, some land matter such as sand may also pass through these filters, for instance.

Attention is first brought to FIGS. 7A and 7B which are schematic drawings of alternate integrators 1010 both having a respective filter plate 1012. In these embodiments, an elbow 1190 directs the drawn land matter towards a filter plate 1012 having pores permitting the air to pass through, but maintaining the land matter thereon. In the embodiment shown in FIG. 7A, the elbow 1190 propels the drawn land matter 1210 away from the separation direction 1014 of the separator assembly 1124. More specifically, the general direction in which the land matter 1210 advances along the separator assembly 1124 as it shifts in the separation process is inclined in FIG. 7A. The inclined filter plate 1012 having its lower end towards the separation direction 1014, such as to gravitationally direct the land matter 1210 received thereon towards the inner cavity of the inner sieve. It is understood that the elbow 1190 need not be present, and that the plate 1012 (as well as the integrator output) can be in any direction without departing from the present disclosure.

For instance, FIG. 7B shows a similar filter plate 1012 as in FIG. 7A, but the integrator output 1202 is in the same direction as the separation direction 1014, within the inner cavity of the separator assembly 1124. The plate 1012, in this embodiment, is generally vertical, such as to permit the air 1206 to pass through, but blocking the land matter 1210 which subsequently gravitationally falls onto the inner sieve of the separator assembly 1124.

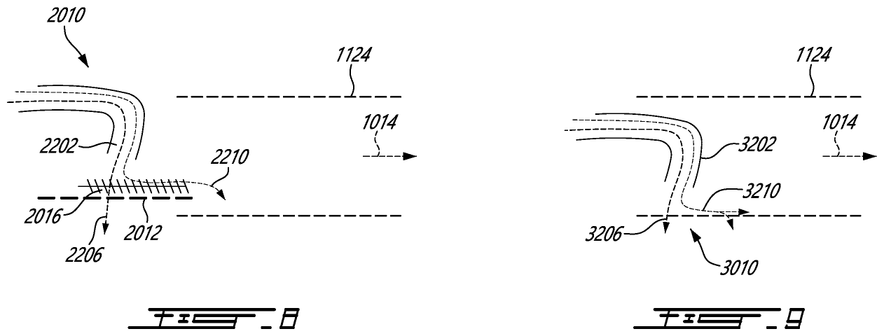

FIG. 8 shows another embodiment of the integrator 2010. In this embodiment, the integrator output 2202 directs the drawn land matter 2210 towards a filter 2012 generally horizontally oriented, having pores permitting the air 2206 to pass through. The integrator 2010 further has a worm screw 2016, which progressively pushes the material having been received towards the inner cavity of the separator assembly 1124. It is understood that in alternate embodiments, the filter 2012 can have a channel which has the worm screw 2016 therein, such as to confine the received land matter 2210 to the channel, without departing from the present disclosure. It is further understood that alternate mechanical conveying means may be used instead of the worm screw.

Referring now to FIG. 9, showing yet another embodiment of the integrator 3010. In this embodiment, an elbow 3202 is used to direct the drawn land matter 3210 radially directly onto the inner sieve. The air 3206, passing through the inner and outer sieves, while the land matter 3210 is then further shifted and separated as described above. It is understood that, while this embodiment shows the elbow 3202 directing the land matter generally downwards, the elbow 3202 can direct the land matter 3210 in any generally radial direction without departing from the present disclosure.

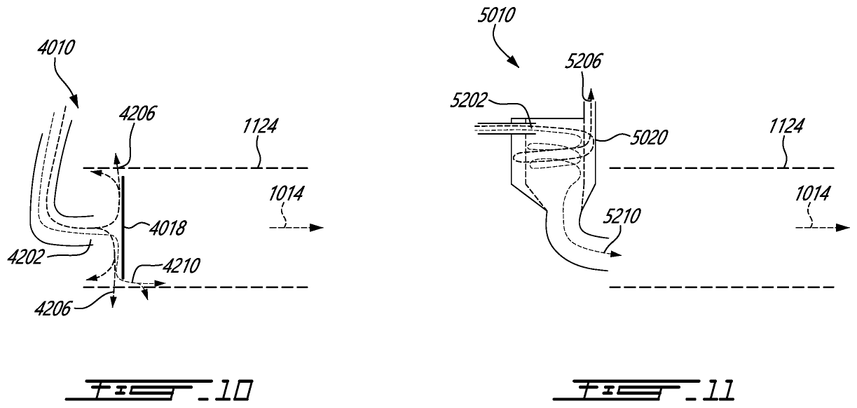

Referring now to FIG. 10, showing yet another alternate embodiment of the integrator 4010. In this embodiment, the integrator input 4202 directs the drawn land matter towards a generally vertically oriented plate 4018 having no pores. The land matter 4210 strikes the plate 4018 and is redirected in a dispersed radial fashion. The land matter 4018 having a larger mass than the air 4206, resulting in it being mainly directed downwardly by gravity, while the air 4206 is free to pass through the inner and outer sieves of the separator assembly.

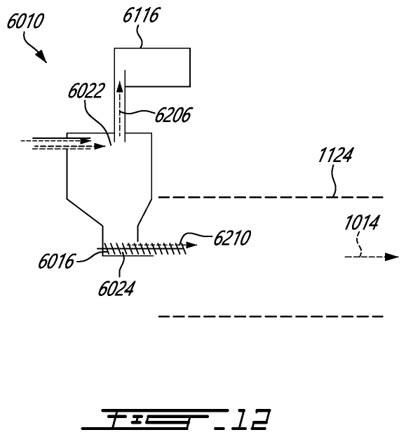

FIG. 11 shows yet another alternate embodiment of the integrator 5010. In this embodiment, the integrator is a cyclonic sieve separator 5020, having a static cylindrical sieve therein with pores letting air 5206 pass through, but capturing the land matter 5210 therein. The integrator input 5202 directs the drawn land matter 5210 from the vacuum generator generally tangentially within the static cylindrical sieve, which is shown as oriented generally vertically. The land matter 5210 is thus propelled such as to spiral around the cylindrical sieve, progressing downwardly due to gravitational forces, until being conveyed to the inner cavity of the separator assembly 1124.

FIG. 12 shows yet another embodiment of the integrator 6010. In contrast to the embodiments discussed above, the integrator in this embodiment is a cyclone 6022, placed upstream of the vacuum generator 6116. The cyclone may be placed downstream of the vacuum generator in some other embodiments. The vacuum generator 6116 forms a vacuum within the cyclone 6022, which in return generates the flow rate through the vacuum conduit. The land matter 6210 drawn is propelled inside the cyclone tangentially to the generally cylindrical body. As the land matter 6210 has a higher mass than the air, the land matter 6210 is sent spiralling against the wall, progressively downwards by gravitation forces, while the air 6206 mainly free of land matter 6210 is pulled generally from the center of the cyclone 6022 towards the vacuum generator 6116. As a vacuum 6116 must be maintained within the cyclone 6022 in order to draw the land matter through the vacuum conduit, a valve 6024 is provided at the bottom portion of the cyclone 6022. In this particular embodiment, the valve 6024 is a worm screw 6016 that pushes the land matter 6210 which collects at the bottom of the cyclone 6022 towards the inner cavity of the separator assembly 1124 while incurring minimal pressure losses within the cyclone 6022. However, it is understood that any other type of valve may of use in such an embodiment, such as a rotation valve, a platypus valve, a counterweighted valve, a trickle valve, a flapper valve, a guillotine valve (or any other intermittently open valve), etc. may be used without departing from the present disclosure. In some embodiments, the integrator can have a vacuum path V extending along a first conduit section having a first cross-section and a second conduit section fluidly connected to the first conduit section and having a second cross-section greater than the first cross-section. In these embodiments, the land matter being carried along the vacuum path V along the first and second conduit sections would behave differently upon reaching a transition between the first and second conduit sections. For instance, the land matter can be forced away from the interior walls of the second conduit section thanks to a drastic change of speed due to the increase in cross-section at the transition.

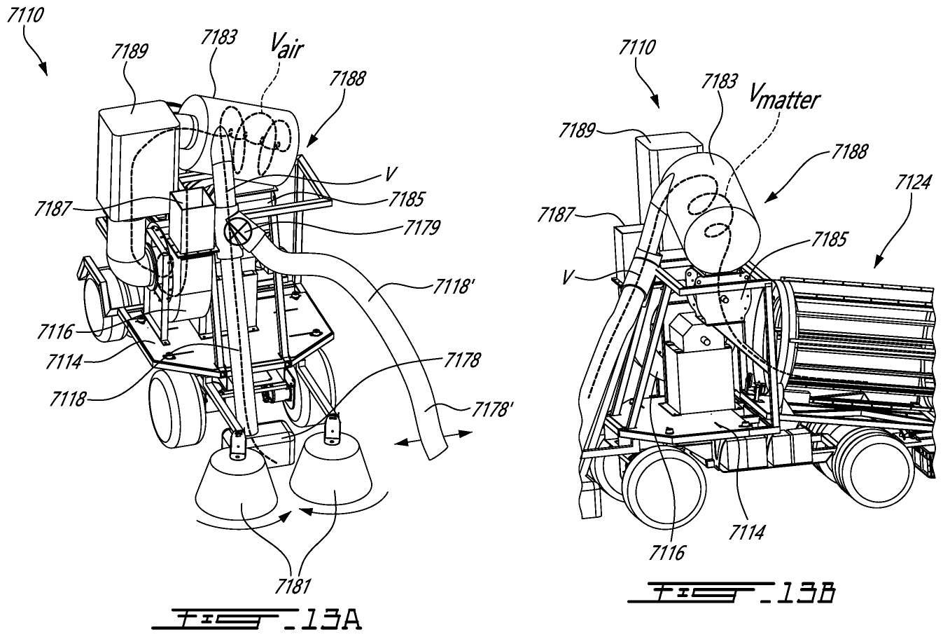

FIGS. 13A and 13B show another example of a wheeled vacuuming system 7110, in accordance with another embodiment. As depicted, the vacuuming system 110 has a frame 7114 to which are mounted a separator assembly 7124 and an integrator 7188 feeding the separator assembly 7124. In this example, the integrator 7188 is in fluid communication with vacuum conduits 7118 and 7118′ which have their respective vacuum inlets 7178 and 7178′. As shown, the vacuum conduit 7118 and associated vacuum inlet 7178 are fixed in position whereas the vacuum conduit 7118′ and vacuum inlet 7178′ are movable as desired. In this specific embodiment, a fluidic valve 7179 is actuatable to open or close either one or both of the vacuum conduits 7118 and 7118′, depending on the application. In some embodiments, the fluidic valve 7179 can be omitted. In such embodiments, vacuuming could be performed through the two vacuum conduits 7118 and 7118′ simultaneously. However, in some embodiments, either one of the vacuum conduits 7118 and 7118′ can be omitted. As illustrated, rotative brushes 7181 are positioned upstream from the fixed vacuum inlet 7178. The rotative brushes 7181 are preferably laterally offset relative to the fixed vacuum inlet 7178 so that when they are rotated in a feeding direction they can feed land matter towards the fixed vacuum inlet 7178. As such, the rotative brushes 7181 can widen the area which is scraped by the wheeled vacuuming system 7110 during use. In some embodiments, the feeding direction of the right-hand side rotative brush is opposite to the feeding direction of the left-hand side rotative brush. For instance, the former feeding direction may be counter clockwise while the latter feeding direction can be clockwise. Although the illustrated rotative brushes 7181 are shown to be rotating about rotation axes that are perpendicular to the ground, the rotative brushes 7181 can be oriented differently. For instance, the rotative brushes 7181 could be rotating about horizontal or otherwise angulated rotation axes. In these specific embodiments, the horizontal or angularly disposed rotation axes can help direct the land matter towards the vacuum inlet 7178. In some embodiments, the rotative brushes 7181 can be omitted as ground scrapers can be used instead. Other examples of matter pushing members or mechanisms can be used as well in some other embodiments.

As shown, the vacuum generator 7116, in this case an air blower, defines a vacuum path V which pulls land matter into the integrator 7188 via the vacuum conduits 7118 and 7118′. As shown in this embodiment, the integrator 7188 is constructed so that the vacuum path V is split into an air path Vair and a matter path Vmatter within a separation chamber 7183. FIG. 13A emphasizes the vacuum path V splitting into the air path Vair whereas FIG. 13B emphasizes the vacuum path V splitting into the matter path Vmatter. As shown in this latter figure, the separation chamber 7183 is obliquely disposed in a manner which forces matter to fall via gravity at the bottom of the separation chamber 7183. Still referring to FIG. 13B, a rotative valve 7185 in fluid communication with the bottom of the separation chamber 7183 receives, again by gravity, the matter via the matter path Vmatter. As can be understood, the rotative valve 7185 is hermetically mounted along the matter path Vmatter so that the land matter can be directed towards the separator assembly 7124 without affecting the vacuum created within the separation chamber 7183 by the vacuum generator 7116. Referring now back to FIG. 13A, the vacuum path V splits into the air path Vair which extends from the separation chamber 7183 towards the vacuum generator 7116 and ultimately to an air outlet 7187. In this example, it was found preferable to provide the air path Vair with an air filter 7189 which can clean the air prior to its rejection in the surrounding environment via the air outlet 7187. Indeed, the air filter 7189 is configured for removing dust which can be carried by the air flowing along the air path Vair. The filter capability or strength of the air filter 7189 can be selected based on local regulations, depending on the embodiment.

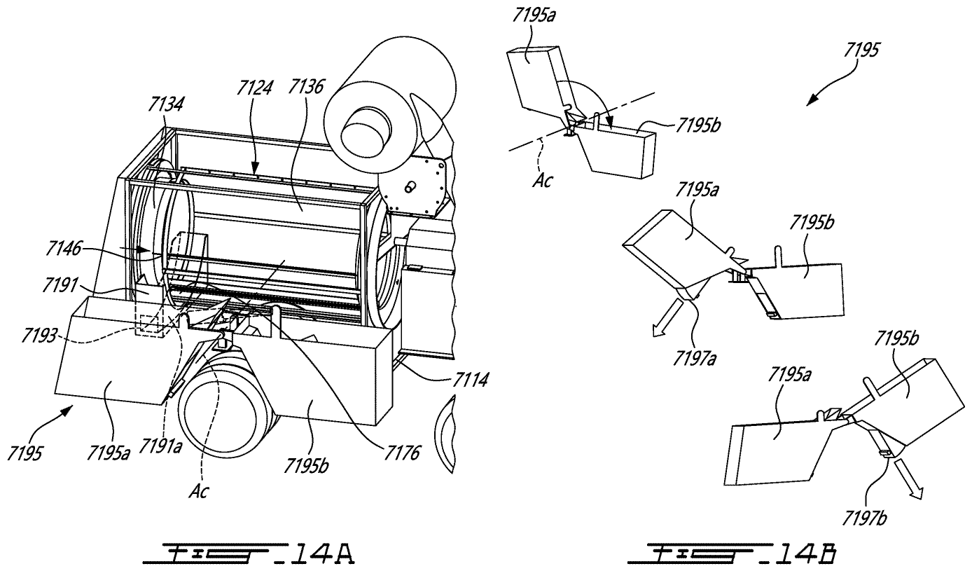

FIGS. 14A and 14B show an example of an undesirable particle receptacle which is particularly relevant in situations where the wheeled vacuuming system 7110 is used for extended periods of time and/or in situations where the density of undesirable particles on the ground is substantial. As shown, the separator assembly 7124 has inner and outer sieves 7134 and 7136 which are designed to capture the undesirable particles, in this case plastic pellets, between the inner and outer sieves 7134 and 7136. As shown, the plastic pellets are captured in the outer sieve 136 and are ultimately conveyed towards a gap 7146 forming a plastic pellet output 7176. A plastic pellet recipient 7191 is coupled to the plastic pellet output 7176. In this particular example, the plastic pellet recipient 7191 has a sloped bottom 7191a which forces the plastic pellet to fall by gravity to one side of the plastic pellet recipient 7191. In some embodiments, the sloped bottom 7191a can be omitted. For instance, the plastic pellet recipient 7191 can be provided with a brushing or scraping member that can move the plastic pellets towards the container opening 7193. In some embodiments, the brushing or scraping member can rotate together with the inner and outer sieves 7134 and 7136. A container opening 7193 positioned on that side of the plastic pellet recipient 7191 is openable as desired to let the plastic pellets exit the plastic pellet recipient 7191 when desired. In some embodiments, the container opening 7193 can be coupled to an auxiliary container assembly 7195 having a first auxiliary container 7195a and a second auxiliary container 7195b. As shown in this embodiment, the first and second auxiliary containers 7195a and 7195b are rotatably mounted directly or indirectly to the frame 7114 of the wheeled vacuuming system 7110 so that they can be tilted about a container axis Ac. As best shown in FIG. 14B, the auxiliary container assembly 7195 offers different modes of operation as to how the first and second auxiliary containers 7195a and 7195b can be used. In a first mode of operation, the first auxiliary container 7195a, when partially or wholly filled with plastic pellets, can be tilted about the container axis Ac so that the plastic pellets contained therein can be transferred to the second auxiliary container 7195b. By doing so, the first auxiliary container 7195a is emptied which can allow the wheeled vacuuming system 7110 to be used for an extended period of time. In a second mode of operation, the first auxiliary container 7195a can be emptied directly into a recuperation container (not shown) via an output port 7197a of the first auxiliary container 7195a. In some cases, the second auxiliary container 7195b can be rolled about the container axis Ac to empty it towards the first auxiliary container 7195a and its output port 7197a. In another mode of operation, the second auxiliary container 7195b can be emptied via its own dedicated output port 7197b. In some embodiments, the auxiliary container assembly 7195 can be detached from the frame 7114 for storing, cleaning, emptying, and the like.

As can be understood, the examples described above and illustrated are intended to be exemplary only. The plastic pellets can come from the plastics industries, the manufacturing industries, the transformation industries, the recycling industries and the transportation industries, to name a few examples. Other types of undesirable particles can be separated using the method and system disclosed herein. For instance, the undesirable particles can include, but are not limited to, plastic pellets or beads, metal pellets or beads, food residue, or a combination thereof. In the embodiments descried herein, the first and second sieves are inner and outer sieves that are concentric with one another, with the outer sieve being around the inner sieve. In some other embodiments, the first and second sieves are longitudinally abutted to one another, or other placed in series with respect to one another. In these latter embodiments, the first and second sieves may have different or similar sieve diameters. The scope is indicated by the appended claims.

What is claimed is:

1. A vacuuming system for separating undesirable particles from land matter, the vacuuming system comprising:
a frame;
a vacuum device mounted to the frame, the vacuum device having a vacuum generator and a vacuum conduit fluidly connected to the vacuum generator, the vacuum generator configured for creating a vacuum path along the vacuum conduit; and
a separator assembly rotatably mounted to the frame, the separator assembly having an inner prismatic sieve having an inner cavity extending about a non-vertical rotation axis and receiving the vacuum path, and an outer prismatic sieve around the inner prismatic sieve, the inner prismatic sieve having inner pores sifting the undesirable particles through the inner prismatic sieve, and the outer prismatic sieve having outer pores smaller than the inner pores, the outer pores capturing the undesirable particles within the outer prismatic sieve.

2. The vacuuming system of claim 1 wherein the outer prismatic sieve is longitudinally shorter than the inner prismatic sieve, thereby forming a longitudinal gap at the outer prismatic sieve.

3. The vacuuming system of claim 2 further comprising a receptacle at the longitudinal gap, the receptacle receiving the undesirable particles captured within the outer prismatic sieve.

4. The vacuuming system of claim 3 further comprising an auxiliary container assembly mounted to the frame and coupleable to the receptacle for receiving the undesirable particles therefrom when desired.

5. The vacuuming system of claim 1 wherein the inner prismatic sieve has a plurality of lifters protruding inwardly from an interior surface of the inner prismatic sieve.

6. The vacuuming system of claim 1 wherein an interior surface of the outer prismatic sieve is smooth around the outer pores.

7. The vacuuming system of claim 1 wherein the inner prismatic sieve has a partition mounted inside the inner prismatic sieve, the partition positioned across an axis parallel to the rotation axis and decelerating the undesirable particles moving along the inner prismatic sieve.

8. The vacuuming system of claim 1 further comprising a rotation mechanism engaged with the separator assembly and configured for rotating the inner and outer prismatic sieves about the rotation axis.

9. The vacuuming system of claim 8 wherein the rotation mechanism is engaged with at least one of the inner and outer prismatic sieves via a circumferential rib.

10. The vacuuming system of claim 9 wherein the rotation mechanism has a motor driving rotation of a wheel frictionally engaged with the circumferential rib.

11. The vacuuming system of claim 1 wherein a radial distance between the inner prismatic sieve and the outer prismatic sieve ranges between 1 inch and 6 inches, and most preferably between 2 inches to 3 inches.

12. The vacuuming system of claim 1 wherein the inner prismatic sieve has a slat having a length extending longitudinally within the inner prismatic sieve and a width extending radially inwardly towards a center of the inner prismatic sieve.

13. The vacuuming system of claim 1 further comprising an integrator encompassing part of the vacuum path, the integrator having a separation chamber in which the vacuum path is split into an air path leading to a surrounding environment and a matter path leading towards the inner cavity of the inner prismatic sieve.

14. The vacuuming system of claim 13 wherein the integrator has an air filter across the air path, the air filter capturing dust carried by the air along the air path.

15. The vacuuming system of claim 13 wherein the integrator has a rotative valve hermetically mounted at a bottom of the separation chamber, the rotative valve carrying the land matter from the separation chamber to the inner sieve while maintaining a vacuum.

16. A method of separating undesirable particles from land matter, the method comprising:
accelerating the land matter along a vacuum path leading to a cavity of an inner prismatic sieve;
rotating the inner prismatic sieve about a non-vertical rotational axis, said rotating including gravitationally sifting the undesirable particles from coarse land matter through the inner prismatic sieve and towards an outer prismatic sieve; and
rotating the outer prismatic sieve about the non-vertical rotational axis, said rotating including gravitationally sifting fine land matter from the undesirable particles through the outer prismatic sieve and capturing the undesirable particles within the outer prismatic sieve.

17. The method of claim 16 further comprising decelerating the land matter prior to arrival into the cavity of the inner prismatic sieve.

18. The method of claim 16 wherein at least one of the inner and outer prismatic sieves has a rotation speed ranging between 5 and 50 revolutions per minute (RPM).

19. A vacuuming system for separating fine land matter from coarse land matter, the vacuuming system comprising: a frame; a vacuum device mounted to the frame, the vacuum device having a vacuum generator and a vacuum conduit fluidly connected to the vacuum generator, the vacuum generator configured for creating a vacuum path along the vacuum conduit; and a separator assembly rotatably mounted to the frame, the separator assembly having a prismatic sieve having an inner cavity extending about a non-vertical rotation axis and receiving the vacuum path, the prismatic sieve having inner pores sifting the fine land matter through the prismatic sieve and maintaining the coarse land matter therewithin.

20. The vacuuming system of claim 19 wherein the prismatic sieve has a first series of first pores axially followed by a second series of second pores, the first pores having a first dimension different from a second dimension of the second pores.
